(19) United States
(12) Patent Application Publication
(10) Pub. No.: US 2026/0256151 A1
(43) Pub. Date: Sep. 3, 2026

(54) BAKED PRODUCTS

(71) Applicant: Kraft Foods Schweiz Holding GmbH, Zug (CH)

(72) Inventors: Kaustuv Bose, Birmingham (GB); Sumanta Ghatak, Mumbai (IN); Mohamed Khan, Mumbai (IN); Shantanu Samant, Mumbai (IN); Pranay Banerjee, Thane (IN)

(21) Appl. No.: 18/876,181

(22) PCT Filed: Jun. 13, 2023
(86) PCT No.: PCT/EP2023/065771

§ 371 Date: Dec. 17, 2024

(30) Foreign Application Priority Data
Jun. 20, 2022 (IN) 202241035195

(51) Int. Cl. A21D 13/38; A21D 13/32; A23G 1/00; A23G 1/36; A23G 1/40

(52) U.S. Cl. CPC A21D 13/38; A21D 13/32; A23G 1/0036; A23G 1/36; A23G 1/40

(57) ABSTRACT

The invention provides a baked product comprising a farinaceous casing enclosing a filling, wherein the filling comprises sucrose and lactose in a ratio of between 5:1 and 10:1 sucrose to lactose, and wherein the total concentration of sucrose and lactose is between 45 and 75 wt. % of the filling.

### TECHNICAL FIELD OF THE INVENTION

The present invention relates to baked products enclosing a filling and to methods of manufacturing fillings for said products.

### BACKGROUND TO THE INVENTION

There is a continuing desire to provide new baked products and eating experiences for consumers. Filled baked products, especially those containing chocolate-flavoured fillings, make up one such area of increasing interest.

Progress has been made in the field and a range of filled baked products are commercially available. Efforts have largely focused on improving filling flavour profile and much less work has been done on improving the texture and rheology of the filling. This is a key area in need of investigation, as mouthfeel and texture are as important as flavour when it comes to assessing overall consumer experience.

It would be advantageous to produce filled baked products that contain a filling having a gooey or runny and/or liquid milk chocolate consistency. This has been difficult to achieve previously, and the majority of attempts have at most produced relatively viscous pastes.

Problems typically occur when baking a filled dough product. Baking is known to cause conventional fillings to dry up and solidify, thus severely affecting their rheological and textural properties. Fillings have also been found to char or burn on baking. Overall, this has led to the production of baked products with fillings having far from optimal flow, post-processing.

It is an aim of embodiments of the present invention to address one or more of the above problems by providing a filled baked product, which may provide one or more of the following advantages:
Contains a filling with a thin gooey or runny texture/consistency, preferably which flows or oozes out when the baked product is broken open or bitten into.
Contains a bake-stable filling that retains its rheological, olfactory, and/or gustatory properties on baking of the filled product.
Contains a filling that does not dry out and/or burn/char when the filled product is baked.
Contains a filling that is easily processable using conventional equipment and machinery.

It is also an aim of embodiments of the present invention to overcome or mitigate at least one problem of the prior art, whether expressly described herein or not.

### SUMMARY OF THE INVENTION

According to a first aspect of the invention, there is provided a baked product comprising a farinaceous casing enclosing a filling, wherein the filling comprises sucrose and lactose in a ratio of between 5:1 and 10:1 sucrose to lactose, and wherein the total concentration of sucrose and lactose is between 45 and 75 wt. % of the filling.

A filling containing sucrose and lactose at such concentrations and ratios provides for a bake-stable filling with anti-char and anti-burn properties. Furthermore, the filling does not dry out while baking and is able to maintain its rheological, olfactory and gustatory properties. Such a ratio of sucrose to lactose also provides for enhanced flavour delivery and balanced milk chocolate sensorials/milkiness of the baked product.

By “farinaceous” we mean that the casing includes a material which comprises or consists of starch.

In some embodiments, the filling comprises a sucrose to lactose ratio of at least 5.5:1, or at least 6:1, 6.5:1, 7:1, 7.5:1, 8:1, 8.5:1, 9:1, or of at least 9.5:1. The filling may comprise a sucrose to lactose ratio of no greater than 9.5:1, or no greater than 9:1, 8.5:1, 8:1, 7.5:1, 7:1, 6.5:1, 6:1, or of no greater than 5.5:1.

The ratio of sucrose to lactose may be between 5.5:1 and 10:1, or between 6:1 and 10:1, or between 6.5:1 and 10:1, or between 7:1 and 10:1, or between 7.5:1 and 10:1, or between 8:1 and 10:1. The ratio of sucrose to lactose may be between 5.5:1 and 9:1, or between 6:1 and 9:1, or preferably between 6.5:1 and 9:1, or between 7:1 and 9:1, or between 7.5:1 and 9:1, or between 8:1 and 9:1. The ratio of sucrose to lactose may be between 5.5:1 and 8:1, or between 6:1 and 8:1, or preferably between 6.5:1 and 8:1, or between 7:1 and 8:1, or between 7.5:1 and 8:1.

In preferred embodiments, the ratio of sucrose to lactose may be around 6.5:1, or around 7:1, or around 7.5:1, or around 8:1, or around 8.5:1.

Such ratios of sucrose to lactose provide the filling with improved resistance to charring and burning, and ensure that the desired rheological, olfactory and gustatory properties of the filling are retained post-baking. Optimised ratios further provide for improved flavour delivery, in particular through improved sweetness and milkiness.

In some embodiments, the filling comprises sucrose in a total concentration of at least 5 wt. % of the filling, or at least 10, 15, 20, 30, 35, 40, or at least 45 wt. % of the filling. The filling may comprise sucrose in a total concentration of no greater than 75 wt. % of the filling, or no greater than 70, 65, 60, 55, or of no greater than 50 wt. % of the filling. The filling may comprise sucrose in a total concentration of between 5-75 wt. % of the filling, or between 10-70, 15-65, 20-60, 25-55, 30-55, 35-65, or preferably between 40-60, or between 45-55 wt. % of the filling.

In some embodiments, the filling comprises lactose in a total concentration of at least 0.5 wt. % of the filling, or at least 1, 1.5, 2, 2.5, 3, 3.5, 4, 4.5, 5, 5.5, 6, 6.5, or in a total concentration of at least 7 wt. % of the filling. The filling may comprise lactose in a total concentration of no greater than 50 wt. % of the filling, or of no greater than 45, 40, 35, 30, 25, 20, 15, 14, 13, 12, 11, 10, 9.5, 9, 8.5, or of no greater than 8 wt. % of the filling. The filling may comprise lactose in a total concentration of between 0.5-25 wt. % of the filling, or between 1-20, 1.5-15, 2-14, 2.5-13, 3-12, 3.5-11, 4-10, or preferably between 5-9, 6-8, or between 7-8 wt. % of the filling.

In some embodiments, the total concentration of sucrose and lactose in the filling is at least 50 wt. % of the filling, or at least 55, 60, 65, or at least 70 wt. % of the filling. The total concentration of sucrose and lactose in the filling may be no greater than 70 wt. %, or no greater than 65, 60, 55, or no greater than 50 wt. % of the filling. The total concentration of sucrose and lactose in the filling may between 50-70 wt. %, or between 50-65, or preferably between 50-60, or the total concentration may be between 55-70, or preferably between 55-65, or between 55-60 wt. % of the filling.

In some embodiments, the filling comprises sucrose and lactose in a sucrose to lactose ratio independently selected from: between 6:1 and 10:1, between 6:1 and 9:1, and between 6:1 and 8:1; and the total concentration of sucrose and lactose in the filling is independently selected from: 50-65 wt. %, 55-65 wt. %, and 55-60 wt. %.

In some embodiments, the filling comprises sucrose and lactose in a sucrose to lactose ratio independently selected from: between 6.5:1 and 10:1, between 6.5:1 and 9:1, and between 6.5:1 and 8:1; and the total concentration of sucrose and lactose in the filling is independently selected from: 50-65 wt. %, 55-65 wt. %, and 55-60 wt. %.

In some embodiments, the filling comprises sucrose and lactose in a sucrose to lactose ratio independently selected from: between 7:1 and 10:1, between 7:1 and 9:1, and between 7:1 and 8:1; and the total concentration of sucrose and lactose in the filling is independently selected from: 50-65 wt. %, 55-65 wt. %, and 55-60 wt. %.

In some embodiments, the lactose is obtained from a dairy source. The dairy source may be independently selected from: milk, whey, cream, butter, yoghurt, cheese, and combinations thereof.

In some embodiments, the filling comprises at least one oil having a smoke point of at least 180° C.

In some embodiments, the oil with a smoke point of at least 180° C. is present in a total amount of at least 5 wt. % of the filling, or at least 10, 15, or at least 20 wt. % of the filling. The oil with a smoke point of at least 180° C. may be present in a total amount of no greater than 80 wt. % of the filling, or no greater than 75, 70, 65, 60, 55, 50, 45, or no greater than 40 wt. % of the filling. The oil with a smoke point of at least 180° C. may be present in a total amount of between 5-55 wt. % of the filling, or between 10-50, 15-45, or preferably between 20-40 wt. % of the filling.

Statements of invention below relating to the second aspect of the invention below or to any other aspect of the invention may also be applied mutatis mutandis to the first aspect of the invention.

According to a second aspect of the invention, there is provided a baked product comprising a farinaceous casing enclosing a filling, wherein the filling comprises at least one oil having a smoke point of at least 180° C., the at least one oil being present in an amount of between 20 and 40 wt. % of the total weight of the filling.

A filling containing such an oil in such amounts benefits from optimised flowability and processability. The filling is of a runny and gooey consistency that allows it to easily flow from the baked product when it is broken open or bitten into. The rheological properties of the filling also make it easily processable using conventional equipment.

Furthermore, the oil with a smoke point of at least 180° C. suffers minimally from undesired migration out of the filling and from undesired fat separation and crystallisation, which adversely affect the flowabilities of many fillings of the prior art.

Statements of invention above relating to the first aspect of the invention may also be applied to the second aspect of the invention.

At least one oil with a smoke point of at least 180° C. may contain at least one oleic acid. In some embodiments, at least one oil with a smoke point of at least 180° C. has a total oleic acid content of at least 5%, or at least 10, 15, 20, 25, 30, 35, or at least 40%. At least one oil with a smoke point of at least 180° C. may have a total oleic acid content of no greater than 75%, or no greater than 70, 65, 60, 55, 50, or no greater than 45%. At least one oil with a smoke point of at least 180° C. may have a total oleic acid content of between 10-75%, or between 15-70, 20-65, 25-60, 30-55, preferably between 35-50, or between 39-45%.

At least one oil with a smoke point of at least 180° C. may contain at least one linoleic acid. In some embodiments, at least one oil with a smoke point of at least 180° C. has a total linoleic acid content of at least 1%, or at least 2, 3, 4, 5, 6, 7, 8, 9, or at least 10%. At least one oil with a smoke point of at least 180° C. may have a total linoleic acid content of no greater than 30%, or no greater than 25, 20, 18, 16, 15, 14, or no greater than 13%. At least one oil with a smoke point of at least 180° C. may have a total linoleic acid content of between 1-30%, or between 2-28, 3-26, 4-24, 5-22, 6-20, 7-18, 8-16, 9-15, 9-14, or between 10-13%.

In some embodiments, at least one oil has a smoke point of at least 185° C., or at least 190, 195, 200, 205, or preferably at least 210, 215, 220, 225, 230, 235, 240, 245, 250, 255, 260, 265, or at least 270° C. Statements of invention referring to the oil with a smoke point of at least 180° C. may equally be applied to the oil having a higher smoke point as described above.

In some embodiments, at least one oil with a smoke point of at least 180° C. has a solid fat content at 30° C. of less than 25 wt. % of the oil, or of less than 20, 18, 16, 14, 13, 12, 11, or preferably of less than 10, or of less than 9 wt. % of the oil.

In some embodiments, at least one oil with a smoke point of at least 180° C. has a solid fat content at 25° C. of at least 2, 4, 6, 8, or at least 10 wt. % of the oil. At least one oil with a smoke point of at least 180° C. may have a solid fat content at 25° C. of no greater than 30 wt. %, or of no greater than 25, 20, or preferably of no greater than 18, 17, 16, 15, 14, or of no greater than 13 wt. %. At least one oil with a smoke point of at least 180° C. may have a solid fat content at 25° C. of between 2-25 wt. % of the oil, or between 3-20, 4-19, 5-18, 6-17, 7-16, 8-15, 9-14, or preferably between 10-13 wt. % of the oil. In some embodiments, at least one oil with a smoke point of at least 180° C. has a solid fat content at 25° C. of between 10-25 wt. % of the oil, or between 10-20, or preferably of between 10-18, 10-17, 10-16, 10-15, 10-14, or between 10-13 wt. % of the oil.

In some embodiments, at least one oil with a smoke point of at least 180° C. has a solid fat content at 20° C. of at least 5 wt. % of the oil, or at least 7, 9, 10, 12, 14, 16, or at least 18 wt. % of the oil. At least one oil with a smoke point of at least 180° C. may have a solid fat content at 20° C. of no greater than 40 wt. % of the oil, or of no greater than 35, 30, 28, 26, 24, or of no greater than 22 wt. % of the oil. At least one oil with a smoke point of at least 180° C. may have a solid fat content at 20° C. of between 5-35 wt. % of the oil, or of between 10-30, 15-25, or preferably between 18-25, or between 18-22 wt. % of the oil.

In some embodiments, at least one oil with a smoke point of at least 180° C. has a solid fat content at 15° C. of at least 10 wt. % of the oil, or at least 12, 14, 16, 18, 20, 22, 24, 26, 28, 30, 32, or at least 34 wt. % of the oil. At least one oil with a smoke point of at least 180° C. may have a solid fat content at 15° C. of no greater than 55 wt. % of the oil, or no greater than 50, 48, 46, 44, 42, 40, or of no greater than 38 wt. % of the oil. At least one oil with a smoke point of at least 180° C. may have a solid fat content at 15° C. of between 15-55 wt. % of the oil, or of between 20-50, 25-45, or preferably between 30-40, or between 32-39, or between 34-38 wt. % of the oil.

In some embodiments, at least one oil with a smoke point of at least 180° C. has a solid fat content of less than 13 wt. %, preferably less than 10 wt. %, more preferably less than 9 wt. % of the oil at 30° C.; and has a solid fat content of 10-18 wt. %, or 10-13 wt. % of the oil at 25° C.

In some embodiments, at least one oil with a smoke point of at least 180° C. has a solid fat content of less than 13 wt. %, preferably less than 10 wt. %, more preferably less than 9 wt. % of the oil at 30° C.; and has a solid fat content of 18-25 wt. %, or 18-22 wt. % of the oil at 20° C.

In some embodiments, at least one oil with a smoke point of at least 180° C. has a solid fat content of less than 13 wt. %, preferably less than 10 wt. %, more preferably less than 9 wt. % of the oil at 30° C.; and has a solid fat content of 30-40 wt. %, or 34-38 wt. % of the oil at 15° C.

In some embodiments, at least one oil with a smoke point of at least 180° C. has a solid fat content of 10-18 wt. %, or 10-13 wt. % of the oil at 25° C.; and has a solid fat content of 18-25 wt. %, or 18-22 wt. % of the oil at 20° C.

In some embodiments, at least one oil with a smoke point of at least 180° C. has a solid fat content of 10-18 wt. %, or 10-13 wt. % of the oil at 25° C.; and has a solid fat content of 30-40 wt. %, or 34-38 wt. % of the oil at 15° C.

In some embodiments, at least one oil with a smoke point of at least 180° C. has a solid fat content of 30-40 wt. %, or 34-38 wt. % of the oil at 15° C.; and has a solid fat content of 18-25 wt. %, or 18-22 wt. % of the oil at 20° C.

In some embodiments, at least one oil with a smoke point of at least 180° C. has a solid fat content of less than 13 wt. %, preferably less than 10 wt. %, more preferably less than 9 wt. % of the oil at 30° C.; a solid fat content of 10-18 wt. %, or 10-13 wt. % of the oil at 25° C.; and a solid fat content of 18-25 wt. %, or 18-22 wt. % of the oil at 20° C.

In some embodiments, at least one oil with a smoke point of at least 180° C. has a solid fat content of less than 13 wt. %, preferably less than 10 wt. %, more preferably less than 9 wt. % of the oil at 30° C.; a solid fat content of 10-18 wt. %, or 10-13 wt. % of the oil at 25° C.; and a solid fat content of 30-40 wt. %, or 34-48 wt. % of the oil at 15° C.

In some embodiments, at least one oil with a smoke point of at least 180° C. has a solid fat content of less than 13 wt. %, preferably less than 10 wt. %, more preferably less than 9 wt. % of the oil at 30° C.; a solid fat content of 18-25 wt. %, or 18-22 wt. % of the oil at 20° C.; and a solid fat content of 30-40 wt. %, or 34-48 wt. % of the oil at 15° C.

In some embodiments, at least one oil with a smoke point of at least 180° C. has a solid fat content of 10-18 wt. %, or 10-13 wt. % of the oil at 25° C.; a solid fat content of 18-25 wt. %, or 18-22 wt. % of the oil at 20° C.; and a solid fat content of 30-40 wt. %, or 34-48 wt. % of the oil at 15° C.

In preferred embodiments, at least one oil with a smoke point of at least 180° C. has a solid fat content of less than 13 wt. %, preferably less than 10 wt. %, more preferably less than 9 wt. % of the oil at 30° C.; a solid fat content of 10-18 wt. %, or 10-13 wt. % of the oil at 25° C.; a solid fat content of 18-25 wt. %, or 18-22 wt. % of the oil at 20° C.; and a solid fat content of 30-40 wt. %, or 34-38 wt. % of the oil at 15° C.

Such solid fat contents provide the filling with optimised viscosity and flowability.

In some embodiments, at least one oil with a smoke point of at least 180° C. has a melting point of at least 8° C., or at least 10, 12, 14, 16, or at least 18° C. At least one oil with a smoke point of at least 180° C. may have a melting point of no greater than 30° C., or no greater than 28, 26, 24, 22, or no greater than 20° C. At least one oil with a smoke point of at least 180° C. may have a melting point of between 8-30° C., or between 10-28, 12-26, 14-24, 16-22, or preferably between 18-20° C.

In some embodiments, at least one oil with a smoke point of at least 180° C. comprises an interesterified and/or blended fat/oil.

In some embodiments, at least one oil with a smoke point of at least 180° C. comprises a fractionated and/or non-hydrogenated oil. In some embodiments, at least one oil comprises fractionated and/or non-hydrogenated palm oil.

In particularly preferred embodiments, at least one oil comprises palm olein. Palm olein provides for particularly optimal rheological properties. Fillings possess excellent texture and display enhanced processability, flowability, and handling performance. In some embodiments, palm olein is the only oil with a smoke point of at least 180° C. in the filling. Palm olein may be the only fat/oil in the filling.

In some embodiments, the oil having a smoke point of at least 180° C. is present in an amount of at least 21 wt. % of the total weight of the filling, or at least 22, 23, 24, 25, or at least 26 wt. % of the total weight of the filling. The oil having a smoke point of at least 180° C. may be present in an amount of no greater than 39 wt. % of the total weight of the filling, or no greater than 38, 37, 36, 35, 34, 33, 32, 31, 30, 29, 28, or no greater than 27 wt. % of the total weight of the filling. The oil having a smoke point of at least 180° C. may be present in an amount of between 20-35 wt. % of the total weight of the filling, or between, 20-30 wt. %, or preferably between 25-30 wt. %, or between 25-28 wt. % of the total weight of the filling. The oil having a smoke point of at least 180° C. may be present in an amount of between 22-38 wt. % of the total weight of the filling, or between 24-36, 24-34, 24-32, 24-30, 24-29, 25-29, or between 26-28 wt. % of the total weight of the filling.

In some embodiments, the filling comprises a single oil, preferably an oil with a smoke point of at least 180° C. as described in the statements above. The filling may comprise a single oil with a smoke point of at least 180° C. The filling may comprise 2, 3, 4, 5, or more oils with a smoke point of at least 180° C. The filling may not contain further fats and/or oils other than the oil with a smoke point of at least 180° C. In other embodiments, the filling comprises at least one further oil and/or fat in addition to the oil with a smoke point of at least 180° C.

In some embodiments, the filling comprises at least one further fat/oil independently selected from the group comprising: milk fat, non-milk fat, and combinations thereof. Non-milk fats/oils may be selected from the group comprising: cocoa butter, vegetable fat/oil, nut fat/oil, and combinations thereof.

CBSs are non-tempering, non-lauric fats differing in composition from cocoa butter. CBSs are produced by fractionation and hydrogenation of oils rich in C16 and C18 fatty acids, forming trans acids, which increases the solid phase of the fat. Suitable sources for CBSs include soya, cottonseed, peanut, rapeseed and corn (maize) oil.

In some embodiments, the filling further comprises milk fat. The milk fat may be present in an amount of no greater than 20 wt. % of the total combined amount of fat and oil in the filling, or no greater than 15, 10, 9, 8, 7, 6, 5, 4, 3, 2, or no greater than 1 wt. % of the total combined amount of fat and oil in the filling.

In some embodiments, the oil with a smoke point of at least 180° C. may be present in an amount of at least 50 wt. % of the total combined amount of fat and oil in the filling, or at least 55, 60, 65, 70, 75, 80, 85, 90, 91, 92, 93, 94, 95, 96, 97, 98, or at least 99 wt. % of the total combined amount of fat and oil in the filling. In some preferred embodiments, the oil with a smoke point of at least 180° C. may comprise 100% of the total combined amount of fat and oil in the filling.

In some embodiments, the total combined amount of fat and oil in the filling comprises in total at least 5 wt. % of the filling, or at least 10, 15, 20, or at least 25 wt. %, or preferably at least 26 wt. % of the filling. The total combined amount of fat and oil in the filling may comprise in total no greater than 80 wt. % of the filling, or no greater than 75, 70, 65, 60, 55, 50, 45, 40, or preferably no greater than 35, or no greater than 30 wt. % of the filling. The total combined amount of fat and oil in the filling may comprise in total between 5-55 wt. % of the filling, or between 10-50, 15-45, preferably between 20-40, 25-35, or between 25-30 wt. %, or between 26-28 wt. % of the filling. In some embodiments, the oil with a smoke point of at least 180° C. may be present in these amounts.

Such fat/oil amounts provide for optimal filling flowability and resistance to drying of the filling during baking.

In some embodiments, the filling comprises at least one sweetener independently selected from the group comprising: a sugar, a sugar replacer, and combinations thereof. The or each sugar replacer may be independently selected from the group comprising: bulking agents (which may be selected from the group comprising an oligosaccharide, polysaccharide, sugar alcohol and combinations thereof), artificial sweeteners, non-nutritive natural sweeteners, protein-based sugar replacers, and combinations thereof.

In some embodiments, the sweetener comprises a sugar. The or each sugar may comprise a nutritive monosaccharide and/or disaccharide. The or each sugar may be independently selected from the group comprising: glucose, fructose, galactose, sucrose, lactose, maltose, combinations thereof and hydrated forms thereof.

In some embodiments, the filling contains 5 sweeteners, or 4, 3, or 2 sweeteners, or the filling contains a single sweetener. Preferably, at least one sweetener is a sugar, preferably a nutritive disaccharide. In some embodiments, all the sweeteners in the filling are sugars. In preferred embodiments, the filling contains two sweeteners, preferably sugars, more preferably nutritive disaccharides.

In some embodiments, the total amount of sweetener in the filling is at least 15 wt. % of the filling, or at least 20, 25, 30, 35, 40, 45, 50, or at least 55 wt. % of the filling. In some embodiments, the total amount of sweetener in the filling is no greater than 95 wt. %, or no greater than 90, 85, 80, 75, 70, 65, or no greater than 60 wt. % of the filling.

In some embodiments, the total amount of sweetener in the filling is between 20-90 wt. %, or between 25-85 wt. %, or between 30-80 wt. %, or between 35-75 wt. %, or between 40-70 wt. %, or between 45-65 wt. %, or between 50-60 wt. %, or between 55-60 wt. % of the filling.

The above statements to the total amount of sweetener may also be applied to the total amount of sugar in the filling or to the total amount of nutritive disaccharide in the filling.

In some embodiments of the second aspect of the invention, the filling comprises sucrose and/or lactose. The sucrose and/or lactose may be present in amounts as described for the first aspect of the invention above. In preferred embodiments, the filling comprises sucrose and lactose. The sucrose and lactose may be present in concentrations as described for the first aspect of the invention above. The sucrose to lactose ratio in the filling may be as described for the first aspect of the invention above. In some embodiments, the filling comprises sucrose and lactose in a ratio of between 5:1 and 10:1 sucrose to lactose, preferably wherein the total concentration of sucrose and lactose is between 45 and 75 wt. % of the filling. In such embodiments, the baked product and/or filling of the second aspect of the invention may preferably be the baked product and/or filling of the first aspect of the invention.

Statements of invention above relating to the baked product and/or filling of the first aspect of the invention may also be applied to the second aspect of the invention.

Such embodiments allow for a highly bake-stable filling which also has optimal flow properties post-processing. The filling is resistant to charring and burning on application of heat. The filling is able to remain in a flowable state post-baking and ooze from the baked product when it is broken apart.

The following statements apply to both the first and second aspects of the invention above.

In some embodiments, the filling further comprises at least one emulsifier. The filling may comprise at least one emulsifier independently selected from the group comprising: lecithin derived from soya bean, safflower, corn etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxyethylene sorbitan monostearate, hydroxylated lecithin, synthetic phospholipids such as ammonium phosphatides, poly glycerol polyricinoleate (PGPR), lactylated fatty acid esters of glycerol and propylene glycol, poly glycerol esters of fatty acids, citric acid esters of fatty acids, propylene glycol mono- and diesters of fats and fatty acids, and combinations thereof. In certain embodiments, the product may comprise at least one emulsifier selected from: soya lecithin, synthetic phospholipids such as ammonium phosphatides, polyglycerol polyricinoleate (PGPR), and combinations thereof.

The filling may comprise the emulsifier in a total amount of no greater than 5 wt. % of the filling, or no greater than 4.5, 4, 3.5, 3, 2.5, 2, 1.5, or no greater than 1 wt. % of the filling. The filling may comprise at least one emulsifier in a total amount of between 0.05-2.5 wt. %, or of between 0.5-2 wt. % of the filling, or between 0.5-1 wt. % of the filling. Addition of at least one emulsifier to the filling allows for easier modification of and better control over its rheology. The emulsifier may act as a rheology modifier.

The filling may preferably comprise a lecithin emulsifier, preferably soya lecithin. The filling may comprise the lecithin in a total amount as described for the emulsifier above. Preferably, the lecithin may be present in a total amount of no more than 2.5 wt. % of the filling, or of no more than 2, 1.5, or of no more than 1 wt. % of the filling. In some embodiments, the filling may only contain lecithin emulsifiers.

Lecithins have been found to interact with the fat matrix in the filling to enhance its post-bake flowability.

In some embodiments, the ratio of the total amount of fat and oil in the filling to the total amount of emulsifier in the filling is at least 5:1, or at least 10:1, 15:1, 20:1, 22.5:1, 25:1, or preferably at least 27.5:1. The ratio of the total amount of fat and oil in the filling to the total amount of emulsifier in the filling may be no greater than 500:1, or no greater than 450:1, or no greater than 400:1, 350:1, 300:1, 250:1, 200:1, 150:1, or no greater than 100:1. The ratio of the total amount of fat and oil to the total amount of emulsifier in the filling may be between 5:1-55:1, or between 10:1-50:1, 15:1-45:1, 20:1-40:1, 25:1-35:1, or between 27:1-33:1. The ratio of the total amount of fat and oil to the total amount of emulsifier in the filling may preferably be around 30:1.

The ratio of the total amount of fat and oil to the total amount of lecithin emulsifier in the filling may be as described above.

In embodiments wherein the filling comprises an oil having a smoke point of at least 180° C., the ratio of the total amount of the oil with a smoke point of at least 180° C. to the total amount of emulsifier in the filling may be as described in the statements above. The ratio of the total amount of the oil with a smoke point of at least 180° C. to the total amount of lecithin emulsifier in the filling may be as described in the statements above.

Such fat/oil to emulsifier ratios provide the filling with optimal rheological behaviour, as well as improved processability, handling, bake-stability and post-bake flowability performance.

In some embodiments, the total combined amount of fat, oil and emulsifier in the filling comprises in total at least 5 wt. % of the filling, or at least 10, 15, 20, or at least 25 wt. %, or preferably at least 26 wt. % of the filling. The total combined amount of fat, oil and emulsifier in the filling may comprise in total no greater than 80 wt. % of the filling, or no greater than 75, 70, 65, 60, 55, 50, 45, 40, or preferably no greater than 35, or no greater than 30 wt. % of the filling. The total combined amount of fat, oil and emulsifier in the filling may comprise in total between 5-55 wt. % of the filling, or between 10-50, 15-45, preferably between 20-40, 25-35, or between 25-30 wt. %, or between 26-28 wt. % of the filling.

In some embodiments, the combined total amount of fat, oil and lecithin emulsifier in the filling may be as described above. In embodiments wherein the filling comprises an oil having a smoke point of at least 180° C., the combined total amount of the oil with a smoke point of at least 180° C. and the emulsifier may be as described above. The combined total amount of the oil with a smoke point of at least 180° C. and the lecithin emulsifier may be as described above.

Such combined fat/oil and emulsifier amounts provide the filling with an optimal viscosity, even post-baking.

In some preferred embodiments, the filling further comprises at least one cocoa ingredient from the group independently selected from the group comprising: cocoa powder, cocoa mass, cocoa liquor, and combinations thereof. In some embodiments, the filling comprises 3 or fewer cocoa ingredients, or 2 or fewer, or a single cocoa ingredient. At least one cocoa ingredient may preferably comprise cocoa powder.

In some embodiments, the cocoa ingredient may be present in the filling in a total amount of at least 1 wt. % of the filling, or at least 2, 3, 4, 5, 6, 7, 8, 9, or at least 10 wt. % of the filling. The cocoa ingredient may be present in the filling in a total amount of no greater than 50 wt. % of the filling, or no greater than 45, 40, 35, 30, 25, 20, or no greater than 15 wt. % of the filling. The cocoa ingredient may be present in the filling in a total amount of between 1-40 wt. % of the filling, or between 2-35, 5-30, 5-25, 5-20, 8-20, 8-15, or in an amount of between 10-15 wt. % of the filling.

Addition of cocoa ingredients provides the filling with a desirable texture and chocolatey flavour.

In some embodiments, the filling comprises one or more additional flavourings. Suitable flavourings may include natural and/or artificial flavours. Flavourings may be independently selected from: synthetic flavour oils and flavouring aromatics; oils; oleo resins; extracts derived from plants, leaves, flowers, fruits, vegetables, and so forth; and combinations thereof. The flavouring may comprise artificial, natural or synthetic flavours independently selected from the group comprising: caramel, vanilla, chocolate, brownie, coffee, lemon, orange, grape, lime, grapefruit, apple, pear, peach, mango, strawberry, raspberry, cherry, plum, pineapple, apricot, and combinations thereof, among others. The flavourings may be present in a total amount of between 0.05-2.0 wt. % of the filling, or between 0.05-1.5, 0.05-1, 0.1-0.8, 0.15-0.6, 0.2-0.5, or between 0.3-0.5 wt. % of the filling.

In some embodiments, the filling is in the form of a liquid or paste.

In some embodiments, the filling has a viscosity at 28° C. and ambient pressure of at least 5000 cP, or at least 6000, 7000, 8000, 9000, or preferably at least 10000 cP, or at least 11000, 12000, or at least 13000 cP. The filling may have a viscosity at 28° C. and ambient pressure of no greater than 25000 cP, or no greater than 24000, 23000, 22000, 21000, or preferably of no greater than 20000 cP, or no greater than 19000, 18000, 17000, 16000, 15000, or of no greater than 14500 cP. The filling may have a viscosity at 28° C. and ambient pressure of between 5000-20000 cP, or between 5000-16000 cP, or between 5000-15000 cP, or between 6000-16000, 7000-16000, 8000-16000, 9000-16000, or preferably between 10000-16000 cP.

The filling may have a Newtonian or a non-Newtonian viscosity profile. The viscosity of the filling may vary depending on applied shear stress. The filling may have a shear thinning viscosity profile, which may be time dependent. In some embodiments, the filling has a thixotropic viscosity profile.

The filling may comprise a particle size of at least 5 microns, or at least 10, 15, or at least 20 microns. The filling may comprise a particle size of no greater than 50 microns, or no greater than 45, 40, 35, or no greater than 30 microns. The particle size of the filling may be between 5-45 microns, or between 10-40, 15-35, or preferably between 20-30 microns.

In some embodiments, the filling has a total water content of no greater than 5 wt. % of the filling, or no greater than 4, 3, 2, or preferably no greater than 1 wt. %, or no greater than 0.95, 0.9, 0.85, 0.8, or of no greater than 0.75 wt. % of the filling. The filling may have a total water content of at least 0.05 wt. % of the filling, or at least 0.1, 0.15, 0.2, 0.25, 0.3, 0.35, 0.4, 0.45, or at least 0.5 wt. % of the filling. The filling may have a total water content of between 0.05-5 wt. % of the filling, or between 0.1-2.5 wt. % of the filling, or between 0.2-2 wt. %, 0.25-1 wt. %, or of between 0.5-1 wt. % of the filling.

Such water contents allow the filling to possess a gooey, runny texture, alongside a desirable final water activity.

In some embodiments, the final water content of the baked product may be as described for the filling above.

In some embodiments, the filling is present in a total amount of at least 0.5 wt. % of the baked product, or at least 1, 2, 3, 4, 5, 10, 15, 20, 25, 30, or at least 35 wt. % of the baked product. In some embodiments, the filling is present in a total amount of no greater than 60 wt. % of the baked product, or of no greater than 55, 50, 45, or preferably no greater than 40 wt % of the baked product.

In some embodiments, the filling is present in a total amount of between 15-60 wt. % of the baked product, or between 20-55, 25-50, 30-45, or preferably between 35-40, or more preferably between 35-38 wt. % of the baked product.

The farinaceous material of the casing may comprise at least one cereal. Suitable cereals may be selected from the group comprising wheat, oats, maize, corn, rye, barley, sorghum, buckwheat, millet, rice, bulgur and quinoa. In some embodiments the farinaceous material comprises wheat.

The farinaceous casing may be formed from a dough or batter, and may comprise a baked dough or batter.

In some embodiments, the baked product is independently selected from the group comprising: a biscuit, a cookie, a cake, a doughnut, a wafer, a cracker, a pretzel, a pastry, a tart, bread, a pie, a waffle, and combinations thereof. In particularly preferred embodiments, the baked product is a filled biscuit or cookie

The farinaceous casing enclosing the filling may preferably define a cavity. Preferably the cavity has a volume in which the filling is contained. The farinaceous casing may comprise a single cavity or multiple cavities. Any number of cavities may be provided with the filling, for example, at least 2 cavities may be present and all cavities or a sub-number of cavities may include the filling.

In some embodiments, the filling occupies at least 5% of the cavity volume of the farinaceous casing, or at least 10, 15, 20, 25, 30, 35, 40, 45, 50, 55, 60, 65, 70, 75, 80, 85, 90, or at least 95% of the cavity volume of the farinaceous casing. The filling may occupy no greater than 95% of the cavity volume of the farinaceous casing, or no greater than 90, 80, 70, 60, 50, 40, 30, 20, or no greater than 10% of the cavity volume of the farinaceous casing.

The filling may be partially or fully surrounded by the farinaceous casing. The outer surface area of the filling may be at least 50% surrounded by the farinaceous casing, or at least 60, 70, 80, or at least 90%, or substantially 100% of the outer surface area of the filling may be surrounded by the farinaceous casing. The farinaceous casing may form a layer of even or uneven thickness around the filling. In some embodiments, the layer has a thickness of at least 1, 2, 3, 4, or at least 5 mm. The layer may have a thickness of no greater than 10, 9, 8, 7, 6, or no greater than 5 cm.

References to “baked” product may also encompass any suitable heated product, such as a fried, steamed, grilled etc. product.

In some embodiments, the baked product is a coated or enrobed product. The baked product may comprise a layer of coating material on a surface thereof, preferably an outer surface. The baked product may comprise a layer of coating material over at least 50% of the outer surface area of the baked product, or over at least 60, 70, 80, 90%, or over substantially 100% of the outer surface area of the baked product. The coating material may comprise a chocolate or non-chocolate confectionery material. The coating material may include but is not limited to one or more coating materials selected from the group comprising: frosting; candy; honey; caramel; toffee; fondant; cream; mousse; gel; jam; sugar; sugar alcohol; syrup; and combinations thereof.

In some embodiments, the baked product has a length or diameter of at least 1, 2, 3, 4, 5, 6, 7, 8, 9, 10, 15, 20, 25, or of at least 30 cm. In some embodiments, the baked product has a length of no greater than 250 cm, or of no greater than 240, 230, 220, 210, 200, 190, 180, 170, 160, 150, 140, 130, 120, 110, 100, 90, 80, 70, 60, 50, 40, 30, or no greater than 20 cm.

The baked product may have a uniform thickness throughout the product, or may vary in thickness across different parts of the product.

In some embodiments, the baked product has a thickness of at least 0.1 cm, or of at least 0.2, 0.3, 0.4, 0.5, 0.75, 1, 1.25, 1.5, 1.75, 2, 2.25, 2.5, 2.75, 3, 3.25, 3.5, 3.75, or of at least 4 cm. In some embodiments, the baked product has a thickness of no greater than 15, 10, 5, 4, 3, 2, or no greater than 1 cm.

The baked product may have a uniform cross-section. The cross-section of the baked product may preferable be circular or ovular. The cross-section may alternatively be square, rectangular, trapezoidal, hemispherical, triangular or the like, for example.

In some embodiments, the baked product may be packaged. Suitable packaging for the baked product may be reclosable or not reclosable (and/or resealable or not resealable) as known to a person skilled in the art.

According to a third aspect of the invention, there is provided a method of manufacturing a filling for a baked product comprising the steps of mixing sucrose and lactose in a ratio of between 5:1 and 10:1, with at least one cocoa solid and at least one oil having a smoke point of at least 180° C., wherein the total amount of sucrose and lactose is between 45 and 75 wt. % of the filling and the total amount of oil having a smoke point of at least 180° C. is between 20 and 40 wt. % of the total weight of the filling.

The filling of the third aspect of the invention may preferably be the filling of the first and/or second aspect of the invention. The baked product of the third aspect of the invention may preferably be the baked product of the first and/or second aspect of the invention.

Statements on invention relating to the first and/or second aspect of the invention above may also be applied mutatis mutandis to the third aspect of the invention.

Statements of invention relating to sucrose and/or lactose in the first and second aspects of the invention above may also be applied to the third aspect of the invention.

In some embodiments, the method comprises mixing the sucrose and lactose with at least one cocoa solid independently selected from the group comprising: cocoa powder, cocoa mass, cocoa liquor, and combinations thereof. In some embodiments, the filling comprises 3 or fewer cocoa solids, or 2 or fewer, or a single cocoa solid. At least one cocoa solid may preferably comprise cocoa powder.

The method may comprise adding the cocoa solid in an amount as described in the statement of invention relating to the amount of cocoa ingredient in the first and second aspect of the invention above.

Statements of invention relating to the oil having a smoke point of at least 180° C. in the first and second aspects of the invention above may also be applied to the third aspect of the invention. In particularly preferred embodiments, at least one oil comprises palm olein.

In some embodiments, the method comprises a mixing and a conching step. In preferred embodiments, a portion of the total amount of oil having a smoke point of at least 180° C. is added in the mixing step and the remainder is added during the conching step. The method may comprise the steps of: (a) mixing sucrose, lactose, at least one cocoa solid, and at least one oil having a smoke point of at least 180° C. to form a first mixture; and then (b) conching the first mixture, preferably with at least one further ingredient.

In some embodiments, the method comprises the steps of: (a) mixing sucrose, lactose, at least one cocoa solid, and at least one oil having a smoke point of at least 180° C. to form a first mixture; and then (b) conching the first mixture with further oil having a smoke point of at least 180° C.

In some embodiments, the mixing step in step (a) is performed at a temperature of at least 10° C., or at least 15, 20, 25, 30, 35, or at least 40° C. The mixing step in step (a) may be performed at a temperature of no greater than 150° C., or no greater than 140, 130, 120, 110, 100, 90, 80, 70, 60, or no greater than 50° C. The mixing step in step (a) may be performed at a temperature of between 10-80° C., or between 15-75, 20-70, 25-65, 30-60, 35-55, or between 40-50° C., or between 45-50° C.

The mixing step in step (a) may be performed for at least 2 minutes, or at least 4, 6, 8, 10, 12, 14, 16, or at least 18 minutes. The mixing step in step (a) may be performed for no greater than 2 hours, or no greater than 1.75, 1.5, 1.25, or no greater than 1 hour, or for no greater than 55 minutes, or no greater than 50, 45, 40, 35, 30, 25, or no greater than 20 minutes. The mixing step in step (a) may be performed for between 2-60 minutes, or between 4-55, 6-50, 8-45, 10-40, 10-30, or between 15-25 minutes, or between 15-20 minutes.

In some embodiments, the method comprises adding at least one emulsifier. Statements of invention relating to emulsifiers for the first and second aspects of the invention may also be applied to the third aspect of the invention. The emulsifier may preferably be present in an amount of no more than 2.5 wt. % of the filling. The emulsifier may be added in step (b) of the method. Step (b) of the method may comprise conching the first mixture with the further oil having a smoke point of at least 180° C. and with the emulsifier.

In some embodiments, the method comprises adding at least one additional flavouring, preferably as described for the first and second aspects of the invention above. The method may comprise adding the additional flavouring in step (b) of the method. Step (b) of the method may comprise conching the first mixture with the further oil having a smoke point of at least 180° C. and with the additional flavouring. The additional flavouring may be added after conching the mixture in step (b), preferably in a further mixing step. The further mixing step may take place in a conch or in a separate mixing vessel.

In some embodiments, step (b) of the method comprises conching the first mixture with the further oil having a smoke point of at least 180° C., with the emulsifier, and with the additional flavouring.

In some embodiments, the ratio of the amount of oil having a smoke point of at least 180° C. added in step (a) to the amount added in step (b) is at least 0.25:1, or at least 0.5:1, 0.75:1, 1:1, 1.25:1, or at least 1.5:1, 1.75:1, or at least 2:1. The ratio of the amount of oil having a smoke point of at least 180° C. added in step (a) to the amount added in step (b) may be no greater than 5:1, or no greater than 4.5:1, 4:1, 3.5:1, 3:1, 2.5:1, or no greater than 2:1. The ratio of the amount of oil having a smoke point of at least 180° C. added in step (a) to the amount added in step (b) may be between 0.25:1 and 5:1, or between 0.5:1 and 4.5:1, or between 0.75:1 and 4:1, or between 1:1 and 3.5:1, or between 1.25:1 and 3:1, or between 1.5:1 and 2.5:1, or between 1.75:1 and 2.25:1. The ratio of the amount of oil having a smoke point of at least 180° C. added in step (a) to the amount added in step (b) may preferably be around 2:1.

In some embodiments, step (b) comprises conching the mixture for a total time of at least 10 mins, or at least 20, 30, 40, 50, 60, 70, 80, 90, or at least 100 mins, 110, 120, 130, 140, 150, 160, 170, or at least 180 mins. Step (b) may comprise conching the mixture for a total time of no greater than 24 hours, or no greater than 22, 20, 18, 16, 14, 12, 10, 8, 6, or for a total time of no greater than 4 hours, or no greater than 3.5 hours, or no greater than 3, 2.5, or no greater than 2 hours. Step (b) may comprise conching the mixture for a total time of between 10-180 minutes, or between 20-170, 30-160, 40-150, 50-140, 60-130, 70-120, or preferably between 80-110 minutes.

In some embodiments, step (b) comprises conching the mixture at a temperature of at least 10° C., or at least 15, 20, 25, 30, 35, 40, 45, 50, 55, or at least 60° C. Step (b) may comprise conching the mixture at a temperature of no greater than 200° C., or no greater than 190, 180, 170, 160, 150, 140, 130, 120, 110, 100, 90, 80, 70 or no greater than 60° C. Step (b) may comprise conching the mixture at a temperature of between 10-110° C., or between 15-105, 20-100, 25-95, 30-90, 35-85, 40-80, 40-75, 45-75, 50-70, 50-65, 50-60, or between 55-65, or between 60-65° C.

In some embodiments, step (b) comprises a pre-fat conching step and a post-fat conching step. In such embodiments, the pre-fat conching step is performed before the post-fat conching step. The pre-fat conching step refers to a conching step performed before addition of further oil to the mixture. The post-fat conching step refers to a conching step performed during and/or after addition of further oil to the mixture. The further oil may preferably comprise the oil having a smoke point of at least 180° C. The post-fat conching step may comprise a pasting step and/or a liquefying step. In some embodiments, the ingredients added to the first mixture in step (b) may be added during the pre-fat conching step and/or during the post-fat conching step. The ingredients may be added during the pasting step and/or during the liquefying step.

In some embodiments, the pre-fat conching step is performed for a total time of at least 30 seconds, or at least 1 min, or at least 2 mins, 3, 4, 5, 6, 7, 8, 9, or at least 10 mins. The pre-fat conching step may be performed for a total time of no greater than 60 mins, or no greater than 50, 40, 30, or no greater than 20 mins. The pre-fat conching step may be performed for a total time of between 1-50 mins, or between 5-40, 5-30, or between 10-20 mins.

The pre-fat conching step may be performed at a temperature of at least 5° C., or at least 10, 15, 20, 25, 30, 35, or at least 40° C. The pre-fat conching step may be performed at a temperature of no greater than 150° C., or no greater than 140, 130, 120, 110, 100, 95, 90, 85, 80, 75, 70, 65, 60, or no greater than 55, or no greater than 50° C. The pre-fat conching step may be performed at a temperature of between 5-85° C., or between 10-80, 15-75, 20-70, 25-65, 30-60, 35-55, or between 40-50° C. In some embodiments, the post-fat conching step is performed for a total time of at least 5 mins, or at least 10, 15, 20, 25, 30, 35, 40, 45, 50, 55, 60, 65, or at least 70 mins. The post-fat conching step may be performed for a total time of no greater than 300 mins, or no greater than 270, 240, 210, 180, 150, 120, or of no greater than 90 mins. The post-fat conching step may be performed for a total time of between 30-130 mins, or between, 40-120, 50-110, 60-100, or between 70-90 mins.

The post-fat conching step may be performed at a temperature of at least 5° C., or at least 10, 15, 20, 25, 30, 35, 40, 45, or at least 50° C. The post-fat conching step may be performed at a temperature of no greater than 150° C., or no greater than 140, 130, 120, 110, 100, 95, 90, 85, 80, 75, 70, 65, or no greater than 60° C. The post-fat conching step may be performed at a temperature of between 10-100° C., or between 15-95, 20-90, 25-85, 30-80, 35-75, 40-70, 45-65, or between 50-60° C. In some embodiments, the pre-fat and post-fat conching steps are performed at the same temperature. The post-fat conching step may alternatively be performed at a higher temperature or a lower temperature than the pre-fat conching step, preferably at a higher temperature.

The pre-fat conching step may be performed at a constant conch rotor speed. The post-fat conching step may be performed under an accelerating conch rotor speed. The conch rotor speed may be increasing throughout the post-fat conching step.

In some embodiments, step (b) further comprises the step of mixing the conched mixture. Additional ingredients such as emulsifiers and flavourings may be added during the further mixing step. The further mixing step may be performed in a conch or may be performed in a separate mixing vessel.

The further mixing step may be performed for at least 5 mins, or at least 10, 15, or at least 20 mins. The further mixing step may be performed for no greater than 60 mins, or no greater than 55, 50, 45, 40, 35, or no greater than 30 mins. The further mixing step may be performed for between 5-45 mins, or between 10-40, 15-35, or between 20-30 mins.

The further mixing step may be performed at a temperature of at least 5° C., or at least 10, 15, 20, 25, 30, 35, or at least 40° C. The further mixing step may be performed at a temperature of no greater than 150° C., or no greater than 140, 130, 120, 110, 100, 95, 90, 85, 80, 75, 70, 65, 60, or no greater than 55, or no greater than 50, or no greater than 45° C. The pre-fat conching step may be performed at a temperature of between 5-80° C., or between 10-75, 15-70, 20-65, 25-60, 30-55, 35-50, or between 40-45° C.

In some embodiments, the method further comprises a size-reduction step, wherein particle size of the filling mixture is reduced. The size-reduction step may comprise refining the filling mixture. The size-reduction step may comprise reducing the particle size of the filling mixture to provide a final particle size according to the statements of invention for the first and second aspects of the invention above.

The size reduction step may be performed on the first mixture before the conching step in step (b)

The size-reduction step may be performed at a temperature of at least 5° C., or at least 10, 15, 20, 25, or at least 30° C. The size-reduction step may be performed at a temperature of no greater than 80° C., or no greater than 70, 60, 50, or no greater than 40° C. The size-reduction step may be performed at a temperature of between 5-65° C., or between 10-60, 15-55, 20-50, 25-45, or between 30-40° C.

The method may further comprise the step of filling a farinaceous casing with the filling, and then baking the casing with the filling enclosed therein to form the baked product. The step of filling the farinaceous casing with the filling is not limited and suitable methods such as stuffing, sandwiching, wrapping, injecting and the like, may be employed. In some embodiments, the farinaceous casing is filled with the filling by co-extraction of a farinaceous material (such as dough) with the filling to provide a filled farinaceous casing. References to baking may also encompass frying, steaming, grilling and other methods of applying heat to the farinaceous casing. The baked product is preferably as described in statements of invention for the first and second aspects of the invention above. The farinaceous casing may comprise dough, such as baking dough and/or confectionery dough.

According to a fourth aspect of the invention, there is provided a method of manufacturing a filling for a baked product, the method comprising the steps of:
(a) mixing sucrose, lactose, at least one cocoa solid, and palm olein to form a first mixture; and
(b) then conching the first mixture with further palm olein and at least one emulsifier.

The method of the fourth aspect of the invention may be the method of the third aspect of the invention. Statements of invention above relating to the method of the third aspect of the invention may also be applied mutatis mutandis to the fourth aspect of the invention.

The filling of the fourth aspect of the invention may preferably be the filling of the first and/or second aspect of the invention. The baked product of the fourth aspect of the invention may preferably be the baked product of the first and/or second aspect of the invention.

Statements on invention relating to the first and/or second aspect of the invention above may also be applied mutatis mutandis to the fourth aspect of the invention.

### DETAILED DESCRIPTION OF THE INVENTION

In order that the invention may be more clearly understood embodiments thereof will now be described, by way of example only.

### Example 1—1^{st} Embodiment of the Baked Product of the Invention

A first embodiment of the baked product of the first and second aspects of the invention was prepared. The product comprised a baked farinaceous casing which contained a filling.

The ingredients of the filling are detailed in Table 1 below.

| Ingredient | Wt. % ingredient in filling |
|---|---|
| Sucrose | 47 |
| Lactose monohydrate | 5.5 |
| Cocoa powder | 11.5 |
| Palm olein oil | 25 |
| Sunflower oil | 8.4 |
| Milk fat | 1 |
| Soya lecithin emulsifier | 1.2 |
| Flavouring | 0.4 |

### Method of Manufacturing the 1^{st} Embodiment of the Invention

### Filling Preparation

The above filling was manufactured by the process summarised below.

Step (a): the sucrose, lactose and cocoa powder were mixed at a temperature of 45-47° C. for 15-20 minutes with 68% of the total amount of palm olein used in the filling to provide a first mixture. The first mixture then underwent a refining step at 32-40° C.

Step (b): the first mixture then underwent pre-fat conching for 10-20 minutes at a temperature of between 40-50° C. The remaining 32% of palm olein, the sunflower oil and the emulsifier were then added to the mixture and the mixture underwent post-fat conching with a continuously accelerating rotor speed for 70-90 minutes at a temperature of between 50-60° C. The mixture was then mixed in the conch with milk fat and flavouring for 20-30 minutes at a temperature of between 40-45° C. prior to discharge. The discharged filling had a viscosity at 28° C. of 4.0-6.0 Pa-s at a shear rate of 60 s⁻¹.

### Farinaceous Casing Preparation and Product Assembly

A dough was prepared and co-extruded with the prepared filling to provide a ball of raw dough surrounding the filling. The ball was then baked in an oven to provide a baked farinaceous product. The product was left to cool on a running belt before packaging.

### Results

The final prepared filling had parameters as detailed in Table 2 below.

TABLE 2

| Parameter | Value | |
|---|---|---|
| Water content | 0.7-1.1 | wt. % |
| Fat content | 34-36 | wt. % |
| Viscosity at 28° C. (60 s⁻¹) | 4.0-6.0 | Pa-s |
| Particle size | 24-28 | μm |

The prepared filling provided a smooth flow and had gooey/runny texture and consistency.

The filling was not adversely affected by baking and retained its rheological, olfactory and gustatory properties. Further, the filling did not burn or char on baking. Advantageously, when the baked product was broken apart, the filling flowed/oozed out of the product freely and resembled liquid milk chocolate even at ambient temperature.

### Example 2—Improved Baked Product of the Invention

An improved baked product of the first and second aspects of the invention was prepared. The product again comprised a baked farinaceous casing which contained a filling.

The ingredients of the improved filling are detailed in Table 3 below.

TABLE 3

| Ingredient | Wt. % ingredient in filling |
|---|---|
| Sucrose | 50 |
| Lactose monohydrate | 7.5 |
| Cocoa powder | 13 |
| Palm olein oil | 27 |
| Soya lecithin emulsifier | 0.9 |
| Flavouring | 0.4 |

### Method of Manufacturing the Improved Product of the Invention

### Filling Preparation

The above improved filling was manufactured by the process summarised below.

Step (a): the sucrose, lactose and cocoa powder were mixed at a temperature of 45-47° C. for 15-20 minutes with 66% of the total amount of palm olein used in the filling to provide a first mixture. The first mixture then underwent a refining step at 32-40° C.

Step (b): the first mixture then underwent pre-fat conching for 10-20 minutes at a temperature of between 40-50° C. The remaining 34% of palm olein and the emulsifier were then added to the mixture and the mixture underwent post-fat conching with a continuously accelerating rotor speed for 70-90 minutes at a temperature of between 50-60° C. The mixture was then mixed in the conch with the flavouring for 20-30 minutes at a temperature of between 40-45° C. prior to discharge. The discharged filling had a viscosity at 28° C. of 8.0-9.0 Pa-s at a shear rate of 60 s⁻¹.

### Farinaceous Casing Preparation and Product Assembly

The farinaceous casing was prepared and the product was assembled in accordance with the method of Example 1 above.

### Results

The final prepared improved filling had parameters as detailed in Table 4 below.

TABLE 4

| Parameter | Value | |
|---|---|---|
| Water content | 0.7-1.1 | wt. % |
| Fat content | 27-30 | wt. % |
| Viscosity at 28° C. (60 s⁻¹) | 8.0-9.0 | Pa-s |
| Particle size | 23-27 | μm |

The filling possessed very high bake-stability and burn- and char-resistance. The rheological properties of the filling both pre- and post-baking were vastly improved. As for the 1^{st} embodiment above, the improved filling had a gooey and runny texture/consistency, which allowed it to flow/ooze out of the baked product when it was broken open. However, the filling showed greatly improved handling and processability. The flowability/consistency also provided for a highly superior mouthfeel and overall milk chocolate experience.

### Example 3—Improved Baked Product of the Invention

The following improved baked product filling of the first and second aspects of the invention was prepared.

The ingredients of the filling are detailed in Table 5 below.

TABLE 5

| Ingredient | Wt. % ingredient in filling |
|---|---|
| Sucrose | 50.3 |
| Lactose monohydrate | 6.6 |
| Cocoa powder | 15.56 |
| Palm olein oil | 26.58 |
| Soya lecithin emulsifier | 0.57 |
| Flavouring | 0.39 |

### Method of Manufacturing the Improved Product of the Invention

### Filling Preparation

The above improved filling was manufactured by the process summarised below.

Step (a): the sucrose, lactose and cocoa powder were mixed at a temperature of 45-47° C. for 15-20 minutes with 85% of the total amount of palm olein and 5% of total amount of emulsifier used in the filling to provide a first mixture. The first mixture then underwent a refining step at 32-40° C.

Step (b): the mixture then underwent pre-fat conching for 10-20 minutes at a temperature of between 40-50° C. The remaining 15% of palm olein and the emulsifier were then added to the mixture and the mixture underwent post-fat conching with a continuously accelerating rotor speed for 70-90 minutes at a temperature of between 50-60° C. The mixture was then mixed in the conch with the flavouring for 20-30 minutes at a temperature of between 40-45° C. prior to discharge. The discharged filling had a viscosity at 28° C. of 8.3 Pa·s at 60 s⁻¹ shear rate.

### Farinaceous Casing Preparation and Product Assembly

The farinaceous casing was prepared and the product was assembled in accordance with the method of Example 1 above.

### Results

The final prepared improved filling had parameters as detailed in Table 6 below.

TABLE 6

| Parameter | Value | |
|---|---|---|
| Water content | 0.8-1 | wt. % |
| Fat content | 27-28 | wt. % |
| Viscosity at 28° C. | 8.0-9.0 | Pa-s |
| Particle size | 23-27 | μm |

The filling possessed very high bake-stability and burn- and char-resistance. Even when the method was scaled up, rheological properties (including texture, flowability and consistency) and handling of the filling both pre- and post-baking were excellent, and the filling was able to flow out of the baked product with ease when it was broken open.

### Example 4—Improved Baked Product of the Invention

The following improved baked product filling of the first and second aspects of the invention was prepared.

The ingredients of the filling are detailed in Table 7 below.

TABLE 7

| Ingredient | Wt. % ingredient in filling |
|---|---|
| Sucrose | 48.7 |
| Lactose monohydrate | 7.5 |
| Cocoa powder | 15.7 |
| Palm olein oil | 26.47 |
| Soya lecithin emulsifier | 1.18 |
| Flavouring | 0.39 |

### Method of Manufacturing the Improved Product of the Invention

### Filling Preparation

The above improved filling was manufactured by the process summarised below.

Step (a): the sucrose, lactose and cocoa powder were mixed at a temperature of 45-47° C. for 15-20 minutes with 84% of the total amount of palm olein and 5% of total amount of emulsifier used in the filling to provide a first mixture. The first mixture then underwent a refining step at 32-40° C.

Step (b): the first mixture then underwent pre-fat conching for 10-20 minutes at a temperature of between 40-50° C. The remaining 16% of palm olein and the emulsifier were then added to the mixture and the mixture underwent post-fat conching with a continuously accelerating rotor speed for 70-90 minutes at a temperature of between 50-60° C. The mixture was then mixed in the conch with the flavouring for 20-30 minutes at a temperature of between 40-45° C. prior to discharge. The discharged filling had a viscosity at 28° C. of 6 Pa·s at 60 s⁻¹ shear rate.

### Farinaceous Casing Preparation and Product Assembly

The farinaceous casing was prepared and the product was assembled in accordance with the method of Example 1 above.

### Results

The final prepared improved filling had parameters as detailed in Table 8 below.

TABLE 8

| Parameter | Value | |
|---|---|---|
| Water content | 0.8-1 | wt. % |
| Fat content | 27-29 | wt. % |
| Viscosity at 28° C. (60 s⁻¹) | 6.0-7.0 | Pa-s |
| Particle size | 23-27 | μm |

The bake-stability and burn- and char-resistance of the improved filling were as for the filling of Example 3 above. As for Example 3, rheological properties and handling of the filling both pre- and post-baking were excellent even on scale-up.

The above embodiments are described by way of example only. Many variations are possible without departing from the scope of the invention as defined in the appended claims.

1: A baked product comprising a farinaceous casing enclosing a filling, wherein the filling comprises sucrose and lactose in a ratio of between 5:1 and 10:1 sucrose to lactose, and wherein the total concentration of sucrose and lactose is between 45 and 75 wt. % of the filling.

2: A baked product as claimed in claim 1, wherein the ratio of sucrose to lactose is between 6:1 and 9:1.

3: A baked product comprising a farinaceous casing enclosing a filling, wherein the filling comprises at least one oil having a smoke point of at least 180° C., the at least one oil being present in an amount of between 20 and 40 wt. % of the total weight of the filling.

4: A baked product as claimed in claim 3, wherein the at least one oil comprises an oil having a solid fat content of less than 10 wt. % of the oil at 30° C.

5: A baked product as claimed in claim 4, wherein the at least one oil comprises an oil having a solid fat content of less than 10 wt. % of the oil at 30° C., and having a solid fat content of 10-18 wt. % of the oil at 25° C.

6: A baked product as claimed in claim 5, wherein the at least one oil comprises an oil having a solid fat content of less than 10 wt. % of the oil at 30° C., a solid fat content of 10-18 wt. % of the oil at 25° C., and a solid fat content of 18-25 wt. % of the oil at 20° C.

7: A baked product as claimed in claim 6, wherein the at least one oil comprises an oil having a solid fat content of less than 10 wt. % of the oil at 30° C., a solid fat content of 10-18 wt. % of the oil at 25° C., a solid fat content of 18-25 wt. % of the oil at 20° C., and a solid fat content of 30-40 wt. % of the oil at 15° C.

8: A baked product as claimed in claim 3, wherein the at least one oil comprises palm olein.

9: A baked product as claimed in claim 3, wherein the filling comprises sucrose and lactose in a ratio of between 5:1 and 10:1 sucrose to lactose, and wherein the total concentration of sucrose and lactose is between 45 and 75 wt. % of the filling.

10: A baked product as claimed in claim 9, wherein the ratio of sucrose to lactose is between 6:1 and 9:1.

11: A baked product as claimed in claim 1, wherein the filling further comprises at least one cocoa ingredient that is independently selected from the group comprising: cocoa powder, cocoa mass, and cocoa liquor.

12: A baked product as claimed in claim 1, wherein the filling further comprises at least one emulsifier.

13: A baked product as claimed in claim 12, wherein the filling comprises lecithin as an emulsifier, preferably in a concentration of no greater than 2.5 wt. % of the filling.

14: A baked product as claimed in claim 1, wherein the filling further comprises milk fat.

15: A method of manufacturing a filling for a baked product comprising the steps of mixing sucrose and lactose in a ratio of between 5:1 and 10:1, with at least one cocoa solid and at least one oil having a smoke point of at least 180° C., wherein the total amount of sucrose and lactose is between 45 and 75 wt. % of the filling and the total amount of oil having a smoke point of at least 180° C. is between 20 and 40 wt. % of the total weight of the filling.

16: A method as claimed in claim 15, wherein the at least one cocoa solid comprises a cocoa solid that is independently selected from the group comprising: cocoa powder, cocoa mass, and cocoa liquor.

17: A method as claimed in claim 15, wherein the method comprises adding at least one emulsifier, and wherein the at least one emulsifier is present in an amount of no more than 2.5 wt. % of the filling.

18: A method as claimed in claim 15, wherein the at least one oil comprises palm olein.

19: A method as claimed in claim 15, wherein the method comprises the steps of:
a. Mixing sucrose, lactose, at least one cocoa solid and at least one oil having a smoke point of at least 180° C. to form a first mixture; and
b. Then conching the first mixture with further oil having a smoke point of at least 180° C. and at least one emulsifier.

20: A method of manufacturing a filling for a baked product, the method comprising the steps of:
a. Mixing sucrose, lactose, at least one cocoa solid, and palm olein to form a first mixture; and
b. Then conching the first mixture with further palm olein and at least one emulsifier.
